(19) United States
(12) Patent Application Publication
(10) Pub. No.: US 2006/0186987 A1
(43) Pub. Date: Aug. 24, 2006

(54) Keyless security system

(76) Inventor: Debbie L. Wilkins, Tulsa, OK (US)

Correspondence Address: JAMES RAY & ASSOCIATES, 2640 PITCAIRN ROAD, MONROEVILLE, PA, 15146, US

(21) Appl. No.: 11/359,802

(22) Filed: Feb. 22, 2006

Related U.S. Application Data
(60) Provisional application No. 60/655,630, filed on Feb. 23, 2005.

(51) Int. Cl. G06K 9/00; G05B 19/00

(52) U.S. Cl. 340/5.53; 340/5.6

(57) ABSTRACT

A keyless security system for enabling a user to gain entry into or start a vehicle includes a keypad for providing a first signal when the user inputs a predetermined character string. A fingerprint scanner provides a second signal characterizing a finger placed in close proximity to such sensor. A controller is coupled to the keypad and to the fingerprint scanner for receiving the first signal and the second signal for comparing each of the first signal and the second signal with a respective default signal stored in a memory and for providing a control signal when each of the first signal and the second signal is substantially identical to its respective default signal, whereby operation of the fingerprint sensor is enabled only when the first signal is substantially identical to its respective default signal.

### CROSS-REFERENCE TO RELATED APPLICATIONS

This application is related to and claims priory from Provisional Patent Application Ser. No. 60/655,630 filed Feb. 23, 2005.

### FIELD OF THE INVENTION

The present invention relates, in general, to keyless security systems and, more particularly, this invention relates to keyless security systems for vehicles and the like which employ a keypad and fingerprint sensor for identifying the legitimate user of such vehicle in order to enable the user to gain entry into and start the vehicle.

### BACKGROUND OF THE INVENTION

As is generally well known, use of conventional keys to gain entry into and start a vehicle is disadvantaged by the fact that such keys are often lost and/or locked inside the vehicle.

Furthermore, it is well known that theft of a vehicle or vehicle components continues to be a growing problem in our society and can be financially and emotionally traumatic to a victim. In response to such theft, vehicle owners have gone to various extremes in trying to protect their property. Some owners remove components such as radios and place a “NO RADIO” sign in the vehicle's window in hopes of discouraging the radio thieves from braking into the vehicle.

Others use metal bars to lock their steering wheels, yet others equip the vehicle with expensive car alarms and tracking systems. Unfortunately, the metal bars may be cumbersome to use and carry in a vehicle and thieves quickly learn how to by-pass even the most sophisticated alarm systems. Additionally, metal bars or alarm systems are not effective when the legitimate owner of the vehicle entered and started such vehicles in an event of a car-jacking.

Various attempts have been made to provide a keyless security system for entering or starting the vehicle. For example, U.S. Pat. No. 6,633,090 to Harter et al discloses a starting system for a vehicle using a fingerprint sensor to generate a signal. A memory has a plurality of authorized fingerprint signals stored therein. A switch is used to generate a start signal. A controller is coupled to the ignition system, the fingerprint sensor, the memory, and switch. The controller compares the fingerprint signal with the authorized signal stored in the memory and enables the ignition system in response to the start signal and the fingerprint signal being equal to an authorized fingerprint signal.

U.S. Pat. No. 6,614,920 to Floyd discloses a fingerprint entry and engine starting system, including a computerized video recorder, and transmitter installed in a driver's door of a vehicle housing a transparent shield. The recorder is positioned under this transparent shield. Since this shield is installed in the vehicle's door handle, a legal user will press the shield upon its left side portion, such as to start the vehicle's engine. As a result, whenever the right hand portion on the shield is pushed by a legal user, the vehicle's door-locks are freed. This is done when the recorder is actuated whereas a fingerprint of a user is transformed from optical information to computer data when the shield is pressed. This data is transmitted and compared with preset data stored in a memory, such that when this preset data matches with transformed data, devices for releasing the vehicle's door-locks are actuated. An ignition switch also actuates a motor of an engine starter, as a match is defined, which drives the starter and starts the engine of the vehicle. This is accomplished, when an activating signal is outputted from a CPU. This CPU defines the memory whereby outputting the activating signal only, whenever the shield is pushed by a legal user for actuating two pushbutton switches.

U.S. Pat. No. 5,938,706 to Feldman teaches a multi element security system for a vehicle and the like that has a central processing unit for storing a driver's fingerprint data and driver's image data, A fingerprint entry unit and a photo image entry unit are connected with the central processing unit so that when a key is inserted, fingerprint data and photo image data of a person inserting the key are transmitted to the central processing unit and compared with the stored data to determine whether that person is an unauthorized driver or not. A unit is provided for connecting the central processing unit with a vehicle battery and a motor pump, so that the vehicle battery and the motor pump are operated only when it is determined that the person is the authorized driver. Another unit is provided for transmitting data about the fingerprints and the photo image of the person to a designated place when it is determined that they are not the authorized driver.

U.S. Pub. No. 2004/0027237 discloses an electronics access security and keyless entry system for providing secured access to a vehicle, a remote communications device for sending a signal for controlling a first set of functions associated with the vehicle, a receiver associated with the vehicle and adapted to receive the signal, an access module operatively connected to the vehicle and adapted to provide control of a second set of functions of the vehicle by a user from outside the vehicle, where a first set of functions may be similar or different from a second set of functions, a plurality of actuators disposed within the vehicle and wherein at least a portion of the first set of functions or at least a portion of the second set of functions are associated with at least one of the plurality of actuators and a controller module electrically connected to the receiver, the access module, and the plurality of actuators.

U.S. Pat. No. 5,337,043 to Gokcebay discloses an access control system that combines card type keys or mechanical keys and lock cylinders with keyholder authentication, so that only the authorized keyholder or keyholders can use a key at an access control point. The user authentication involves a biometric feature such as a fingerprint of the intended keyholder. The fingerprint is digitized, encoded and placed on the bottom edge of the mechanical key for that intended keyholder, preferably along with an encoded keyholder identifying number. An authentication reader at a high security access control point includes a keyway with a reader for the encoded data representing the encoded fingerprint, and also a fingerprint reader for reading the user's fingerprint at each instance of attempted entry. Comparison of the attempted user's fingerprint with the stored fingerprint is made directly at the access control point, so that only the access decision and a keyholder identifying code need be sent to a central processor.

U.S. Pat. No. 5,422,632 to Bucholtz et al; U.S. Pat. No. 4,463,340 to Adkins et al; U.S. Pat. No. 5,420,936 to Fitzpatrick et al; U.S. Pat. No. 5,386,104 to Sime; U.S. Pat. No. 4,327,353 to Beard et al and U.S. Pat. No. 4,210,899 to Swonger et al are representative of related prior art keyless access and anti-theft control systems.

### SUMMARY OF THE INVENTION

According to a first embodiment of the invention, there is provided a keyless security system for enabling a user to change a state of a lock device in order to gain entry into a vehicle. Such system includes a keypad for providing a first signal when the user inputs a predetermined character string. A sensor is employed for providing a second signal characterizing an object placed in close proximity to such sensor. A controller is coupled to the keypad and to the sensor for receiving the first signal and the second signal and comparing them with their respective default signals stored in memory. Controller further provides a control signal when each of the first signal and the second signal is substantially identical to its respective default signal. The state of the lock device is changed in response to such control signal enabling the user to enter the vehicle. Operation of the sensor is enabled only when the first signal received from the keypad is substantially identical to its respective default signal.

According to a second embodiment, the invention provides a keyless security system for enabling a user to start the vehicle. Such system includes a keypad for providing a first signal when the user inputs a predetermined character string. A sensor is employed for providing a second signal characterizing an object placed in close proximity to such sensor. A controller is coupled to the keypad and to the sensor for receiving the first signal and the second signal and for comparing them with their respective default signal stored in a memory. Controller further provides a control signal when each of the first signal and the second signal is substantially identical to its respective default signal. Such control signal is used to enable a switch which is manually activated to start the vehicle. Operation of the sensor is enabled only when the first signal received from the keypad is substantially identical to its respective default signal.

### OBJECTS OF THE INVENTION

It is, therefore, one of the primary objects of the present invention to provide a keyless security system for a vehicle.

Another object of the present invention is to provide a keyless security system for a vehicle which uses a combination of elements to authenticate a legitimate user of such vehicle.

Yet another object of the present invention is to provide a keyless security system for a vehicle which employs a barometric scanner.

A further object of the present invention is to provide a keyless security system for a vehicle which employs a keypad.

Yet a further object of the present invention is to provide a keyless security system for a vehicle which is suitable for entering and starting a vehicle by a plurality of authorized users.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view of a keyless security system of the first embodiment of the present invention employed in combination with a door of a vehicle;

FIG. 2 is a schematic representation of the keyless security system of FIG. 1;

FIG. 3 is an elevation view of a keyless security system of a second embodiment of the present invention employed in combination with a starting system of a vehicle; and

FIG. 4 is a schematic representation of the keyless security system of FIG. 3.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

According to a first embodiment of the invention, there is provided a keyless security system, generally designated 20, for changing a state of a lock device 14 disposed within a door 12 of a vehicle 10.

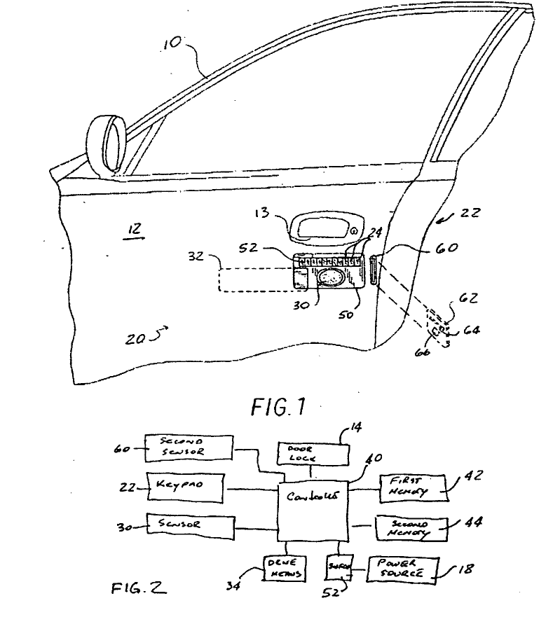

In reference to FIGS. 1-2, such system 20 includes a keypad, generally designated 22, and a sensor means 30 disposed in a predetermined pattern and mounted on an exterior surface of door 12, preferably in close proximity to door handle 13. A controller 40 is provided to control operation of the system 20 and is coupled to various components of the vehicle 10.

The keypad 22 has a predetermined plurality of keys 24, preferably of alpha-numeric type, for enabling a user (not shown) to input a predetermined character string.

The sensor means 30 is provided for sensing a predetermined object. In the presently preferred embodiment, such sensor means 30 is a biometric scanner 30 and, more particularly, a fingerprint scanner 30 of any suitable type capable of converting a fingerprint image into a digital signal.

The controller 40 is preferably microprocessor-based and is further coupled to a first memory 42 and a second memory 44 which are illustrated as separate components in FIG. 2 but may be integral parts of the controller 40. It will be understood that even though the controller 40 is illustrated as a separate element in FIG. 2, it may be integral, in its entirety, to one of the keypad 22 and fingerprint scanner 30 or portions of such controller 40 may be incorporated into both keypad 22 and fingerprint scanner 30.

In normal operation, the user of the vehicle 10 desiring access to such vehicle 10 first inputs such predetermined character string through the keypad 22. In response, keypad 22 generates a keypad signal which is compared by the controller 40 with a default keypad signal stored within the first memory 42. When controller 40 detects that such keypad signal is substantially identical to the default keypad signal, the fingerprint scanner 30 is enabled and generates a sensor signal upon sensing a finger of the user. Such sensor signal is compared by the controller 40 with a default sensor signal stored within a second memory 44. When the controller 40 determines that the sensor signal is substantially identical to such default sensor signal, it generates a control signal which is transmitted to the lock device 14 and changes the state of the lock device 14 from locked to unlocked thus enabling the user to open the door 12 and gain entry into the interior of the vehicle 10.

For additional safety, the controller 40 may compare the default sensor signal with the default keypad signal and establish a correlation between such default signals prior to generating the control signal in order to authenticate that such user is a legal user of the vehicle 10. If, for instance, the user inputs a character string that correlates to an index finger but places the thumb to be scanned, the system 20 will not enable the user to gain entry into the vehicle 10 even if the user is a legitimate user. In this case, the user must start from the beginning.

This additional measure of safety may be particularly advantageous when the vehicle 10 is used by more than one user, for example, when such vehicle 10 is property of a rental company or such vehicle 10 is restrictively used by minors in a household. The management of the rental company or the parents may change the default keypad signal stored in the first memory 42 in order to prevent or enable use of such vehicle 10.

By example, to store a default character string and default fingerprint pattern and to generate corresponding default signals, the user may first enter, by using a keypad 22, a predetermined control character string that is unique for the vehicle 10. Next, the user inputs a character string which is processed by the controller 40 as a default keypad signal and stored in the first memory 42. The user than uses the fingerprint scanner 30 to generate and store a corresponding default fingerprint signal. The user may be required, by way of audio or visual means (not shown), to reenter the default character string and rescan the fingerprint in order to confirm the security combination. It will be appreciated that the procedure is similar to any well known procedure of entering or changing a user ID and a password combination. It will be appreciated that such control character string may be used at a later time to modify a default character string and default fingerprint pattern or enter a plurality of combinations having each of a default character string and default fingerprint pattern, wherein each combination is used for identifying an additional user of the vehicle 10.

The fingerprint scanner 30 may be provided with a cover 32 to protect such fingerprint scanner 30 from undesirable scratches and dents common during use of the vehicle 10 and further protect the fingerprint scanner 30 from the effects of weather. Such cover 32 may be manually operable and, preferably, the system 20 further includes a drive means 34 which is operable in response to the first keypad signal to move the cover 32 for at least uncovering the sensor means 30 thus enabling its operation. Accordingly, a user who enters a character string that does not have a corresponding default in the first memory 42 will not be able to use the fingerprint scanner 32 and will not be able to gain entry into the interior of the vehicle 10. The cover 32 may move in one of a sliding or pivoting motion and the drive means 34 may be further configured to return the cover 32 into a position for covering the fingerprint scanner 30 after the user placed the finger to be scanned. Alternatively, the drive means 34 may be simply configured to either magnetically or mechanically release the cover 32 in response to the first keypad signal enabling the user to manually operate the cover 32.

It will be apparent to those skilled in the art, that the system 20 may include a housing 50 containing such keypad 22, the fingerprint scanner 30 and preferably the controller 40 for enabling simple installation of the system 20 onto the door 12 and for enabling simple retrofit of such vehicle 10.

Furthermore, the system 20 may be provided with a power switch means 52 for supplying electrical power to the system 20 from a power source 18 of the vehicle 10 when the system 20 is to be used. Such power switch means 52 may be integrated into the keypad 22, as best shown in FIG. 1.

If the user cannot present a finger to be scanned due to weather conditions or injury to such finger, the system 20 may further include a second sensor means 60, capable of sensing information stored within a control card 62. Such information may be disposed on a magnetic strip 64 similar to most credit cards, wherein the second sensor means 60 will be adapted for slidingly receiving such control card 62 and will be further adapted with a bar code type reader (not shown) for reading stored information, or the information may be stored on a memory chip 66 and sensed by the second sensor means 60 when the control card 62 is placed in close proximity thereto. When used, the control card 62 generates the control signal to operate the lock device 14 of the vehicle 10 or may be used in combination with the keypad 22 to generate such control signal. It will be understood that the second sensor 60 may be mounted within the housing 58.

It will be appreciated that the second sensor means 60 and the control card 62 are advantageous for storing a default character string and default fingerprint pattern and for generating corresponding default signals when the system 20 is used for the first time or when the system 20 requires changes. Once the user generates such default signals per procedure discussed above, the user may elect to store the control card 62 in a secure place.

It will be apparent to those skilled in the relevant art, that the system 20 eliminates the need to carry conventional car keys and eliminates occurrences of loosing such car keys or locking them within the interior portion of the vehicle 10. Furthermore, the system 20 improves security aspects for gaining entry into and starting the vehicle 10 by using a combination of a simple keypad 22 and simple fingerprint scanner 30 and requiring authentication of the character string inputted through the keypad 22 prior to enabling operation of the fingerprint scanner 30. Additionally, the system 20 visually annunciates to an unauthorized user that the vehicle 10 is provided with additional measure of safety.

According to a second embodiment, the present invention provides a keyless security system, generally designated 120, for operating a starting system 114 of an engine 112 of the vehicle 100.

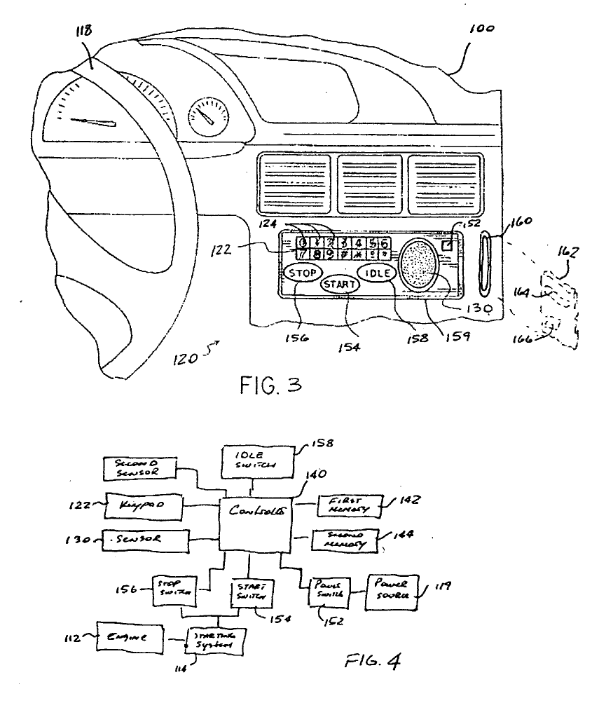

In reference to FIGS. 3-4, such system 120 includes a keypad 122 and a scanner means 130 disposed in a predetermined pattern and preferably mounted on an exterior surface of the instrument panel 116 in close proximity to steering wheel 118. The controller 140 is provided to control operation of the system 120 and is coupled to various components of vehicle 100.

The keypad 122 has a predetermined plurality of keys 124, preferably of alpha-numeric type, for enabling a user (not shown) to input a predetermined character string.

The sensor means 130 is provided for sensing a predetermined object. In the presently preferred embodiment, such sensor means 130 is a biometric scanner 130 and, more particularly, a fingerprint scanner 130 of any suitable type capable of converting a fingerprint image into a digital signal.

The controller 140 is preferably microprocessor-based and is further coupled to a first memory 142 and a second memory 144 which are illustrated as separate components in FIG. 2 but may be integral parts of the controller 140. It will be understood that even though the controller 140 is illustrated as a separate element in FIG. 4, it may be integral, in its entirety, to one of the keypad 122 and fingerprint scanner 130 or portions of such controller 140 may be incorporated into both keypad 122 and fingerprint scanner 130.

In normal operation, the user of the vehicle 100, desiring to start such vehicle 100, first inputs the predetermined character spring through keypad 122. In response, keypad 122 generates a keypad signal which is compared by controller 140 with a default keypad signal stored within first memory 142. When the controller 140 detects that such keypad signal is substantially identical to the default keypad signal, the fingerprint scanner 130 is enabled and generates a sensor signal upon sensing a finger of the user. Such sensor signal is compared by the controller 140 with a default sensor signal stored within a second memory 144. When the controller 140 determines that the sensor signal is substantially identical to such default sensor signal, it generates a control signal which enables the start switch 150. When the user manually operates the start switch 150, it generates a start signal received by the starting system 114 for starting the engine 112.

For additional safety, the controller 140 may compare the default sensor signal with the default keypad signal and establish proper correlation between such signals prior to generating the control signal in order to authenticate that such user is a legal user of the vehicle 100. If, for instance, the user inputs a sequence string that correlates to an index finger but places the thumb to be scanned, the system 120 will not enable the user to start the engine 112 if though the user is a legitimate user. In this case, the user must start from the beginning.

Furthermore, the system 120 is provided with a power switch means 152 for supplying electrical power to the system 120 from a power source 119 of the vehicle 100. Such power switch means 152 is preferably disposed adjacent the keypad 122 and the sensor means 130.

Additionally, the system 120 is provided with a start switch 154 for starting the engine 112, a stop switch 154 for terminating operation of the engine 112 and an idle switch 156 for enabling the user to use various accessories (not shown) without starting the engine 112 of the vehicle 110.

It will be apparent to those skilled in the art, that the system 120 may be provided with a housing 159 containing such keypad 122, the fingerprint scanner 130 and preferably the controller 140 for enabling simple installation of the system 120 onto the instrument panel 114 and for enabling simple aftermarket retrofit of such vehicle 100.

If the user cannot present a finger to be scanned due to weather conditions or injury to such finger, the system 120 may further include a second sensor means 160, capable of sensing information stored within a control card 162. Such information may be disposed on a magnetic strip 164 similar to most credit cards, wherein the second sensor means 160 will be adapted to slidingly received such control card 162 and will be further adapted with a bar code type reader (not shown) for reading stored information, or the information may be stored on a memory chip 166 and sensed by the second sensor means 160 when the control card 162 is placed in close proximity thereto. When used, the control card 162 will generate the control signal to start the engine 112 of the vehicle 100 or may be used in combination with the keypad 122 to generate such control signal.

It will be appreciated that the second sensor means 160 and the control card 162 are advantageous in establishing and storing such default keypad signal and such default sensor signal when the system 120 is used for the first time or when the system 120 requires changes. Once the user stores such default signals per procedure discussed above, the user may elect to store the control card 162 in a secure place.

It will be apparent to those skilled in the relevant art, that the system 120 eliminates the need to use a conventional key in order to start vehicle 100. Furthermore, the system 120 improves security aspects starting the vehicle 100 by using a combination of a simple keypad 122 and simple fingerprint scanner 130 and requiring authentication of the character string inputted through the keypad 122 prior to enabling operation of the fingerprint scanner 130. Additionally, the system 120 visually annunciates to an unauthorized user that vehicle 100 is provided with such additional measure of safety.

It will be understood that the system 20 for controlling a lock device 14 and the system 120 for starting an engine 112 of a vehicle when used in combination provide a keyless security system capable of authenticating the user for gaining entry into and starting the vehicle. The functions performed by the controller 40 and the controller 140 may be integrated and performed by a single controller (not shown) in applications using both system 20 and system 120.

Although the present invention has been shown in terms of the keyless security system for entering and starting a vehicle, it will be apparent to those skilled in the art, that the present invention may be applied to other various devices. For instance, owners of computer systems or electronic cash registers often face difficulty in preventing non-authorized users from gaining access to such devices. By adapting system 20 to cash registers or computer systems, only users having combination of proper access code and fingerprint would be allowed access.

Furthermore, home owners may use such system 20 for gaining entry into their homes. Likewise, business owners could ensure that only current employees have access into the building and not former employees who retained or illegally obtained door lock keys. The combination of the access code and fingerprint scan is advantageous to using only a conventional key or an access card. It will be understood that a retina scanner may be used in place of the fingerprint scanner as these devices are gaining wider acceptance.

Additionally, it will be understood that although the procedure is described in terms of first using a keypad and than using a fingerprint sensor, the procedure may be reversed without adversely impacting operation of the keyless security system of the present invention. Accordingly, the fingerprint sensor will be used prior to inputting the character string into the keypad.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A keyless security system operable by a user to provide at least one control signal, said system comprising:
(a) a keypad for providing a first signal when such user inputs a predetermined character string;
(b) a sensor means for sensing a predetermined object and for providing a second signal characterizing said predetermined object; and
(c) a control means coupled to said keypad and to said sensor means for receiving said first signal and said second signal, for comparing each of said first signal and said second signal with a respective default signal stored in a memory and for providing such control signal when each of said first signal and said second signal is substantially identical to said respective default signal, whereby operation of said sensor means is enabled when said first signal is substantially identical to said respective default signal.

2. The system, according to claim 1, wherein said sensor means is a biometric scanner.

3. The system, according to claim 1, wherein said system includes a housing and said sensor means and said keypad are disposed in a predetermined pattern within said housing.

4. The system, according to claim 1, wherein said system includes a cover means for covering said sensor means.

5. The system, according to claim 4, wherein said cover means is manually operable.

6. The system, according to claim 4, wherein said system further includes a drive means operable in response to said first signal for moving said cover means to at least uncover said sensor means.

7. The system, according to claim 1, wherein said system further includes a second sensor means for reading information stored within a control card.

8. The system, according to claim 1, wherein said system further includes a manually operable power switch means for supplying electrical power to said system from a power source.

9. The system, according to claim 1, wherein said system further includes at least one switch enabled by such control signal to provide a predetermined command signal.

10. A method of controlling a lock device responsive to a control signal, said method comprising the steps of:
(a) providing a user operable keypad for entering a predetermined character string;
(b) generating a keypad signal from said keypad when a user inputs said predetermined character string;
(c) comparing said keypad signal with a default keypad signal stored within a first memory;
(d) operably enabling a sensor means, provided for sensing an object, when said keypad signal is substantially identical to said default keypad signal;
(e) generating a sensor signal from said sensor means upon sensing said object;
(f) comparing said sensor signal with a default sensor signal stored within a second memory;
(g) generating a control signal when said sensor signal is substantially identical to said default sensor signal;
(h) transmitting said control signal to such lock device; and
(i) changing a state of such lock device in response to receipt of said control signal.

11. The method, according to claim 10, wherein said method includes the step of comparing said default sensor signal with said default keypad signal prior to generating said control signal in step (g).

12. The method, according to claim 11, wherein said control signal is generated in step (g) when said default sensor signal correlates to said default keypad signal.

13. The method, according to claim 10, wherein said sensor means is a biometric scanner.

14. The method, according to claim 13, wherein said object is a finger and wherein said biometric scanner is a fingerprint scanner.

15. The method, according to claim 10, wherein said method further includes the step of providing a second sensor means for sensing information stored on a control card.

16. The method, according to claim 15, wherein said control card is used for at least one of generating said default keypad signal, said default sensor signal and generating said control signal.

17. The method, according to claim 10, wherein said method further includes the step of entering a control character string by way of said keypad to generate and store said default keypad signal.

18. The method, according to claim 17, wherein said method further includes the step of generating and storing said default sensor signal when said default keypad signal is generated and stored.

19. The method, according to claim 10, wherein said method further includes the step of generating and storing a plurality of combinations each having a distinct default keypad signal and a distinct default sensor signal for controlling such lock device by a plurality of distinct users.

20. A method of starting an engine of a vehicle, said method comprising the steps of:
(a) providing a user operable keypad disposed in a predetermined location within a vehicle interior for entering a predetermined character string;
(b) generating a keypad signal from said keypad when a user inputs said predetermined character string;
(c) comparing said keypad signal with a default keypad signal stored within a first memory;
(d) operably enabling a sensor means, provided for sensing an object, when said keypad signal is substantially identical to said default keypad signal;
(e) generating a sensor signal from said sensor means upon sensing said object;
(f) comparing said sensor signal with a default sensor signal stored within a second memory;
(g) operably enabling a switch means when said sensor signal is substantially identical to said default sensor signal;
(h) generating a start signal by manually operating said switch means; and
(i) starting such engine in response to said start signal.
